(19) United States
(12) Patent Application Publication
(10) Pub. No.: US 2009/0192879 A1
(43) Pub. Date: Jul. 30, 2009

(54) Lead Rating Systems

(76) Inventors: Michael Hood, Irvine, CA (US); Michael Khristo, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/356,010

(22) Filed: Jan. 19, 2009

Related U.S. Application Data
(60) Provisional application No. 61/022,491, filed on Jan. 21, 2008.

(51) Int. Cl. G06Q 10/00; G06Q 50/00

(52) U.S. Cl. 705/10

(57) ABSTRACT

Systems for rating leads are presented. A lead providing service preferably provides a tagging interface that allows users interested in leads to assign the leads one or more tags. The tags represent metrics by which one or more leads can be rated by other users. A rating interface is also provided to allow users to rate the leads with respect to the tags by setting a rating value according to a rating scale. Leads are presented to users along with the tags and tag ratings that calculated from the rating values submitted by users.

This application claims priority to U.S. provisional application having Ser. No. 61/022,491 filed on Jan. 21, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is information rating technologies.

### BACKGROUND

Leads can be purchased and sold through various lead providing services including those offered by Leadpile™ (http://www.leadpile.com). Unfortunately, Leadpile or other lead providing services offer weak guidance to lead purchasers regarding the quality of leads. This is especially true when lead purchasers have different criteria or perspectives on lead quality. Ideally, a lead providing service should offer lead purchasers multiple perspectives on the quality of leads, possibly through different rating scales, as opposed to merely indicating if a lead has “high” quality or not.

Other web based services other than lead providers allow users to rate various items associated with the service (e.g., products, articles, other users, movies, etc), but are still lacking any depth to rate the items. eBay™ (http://www.ebay.com), for example, only allows users to rate each other as sellers or buyers as opposed rating each other with respect to shipping, customer service, product quality, or other attributes. Other web portals only allow users to rate items or content according to predefined categories or tags, but are limited only to predefined metrics. Greatschools™ (http://www.greatschools.net), for example, has a predefined set of metrics that parents or students can use to rate a school. Currently, there are no known services where a user of the service can establish their own rating metrics that become available to others.

Such approaches are underscored by U.S. patent application publication 2003/0014428 to Mascarenhas titled “Method and System for Document Search System Using Search Criteria Comprised of Ratings Prepared By Experts”. In the Mascarenhas approach, documents are assigned taxonomic indicia based on a commonly known taxonomy where experts in the field rate a document according to the indicia. Just as the previous approaches, the Mascarenhas ratings are another example of where ratings are established a priori by others as opposed to being defined by users actually using the items of interest.

Others have also put forth effort toward allowing users to rate aspects of providing leads. U.S. patent application publication 2006/0041500 to Diana et al. titled “System for Implementing Automated Open Marketing Auctioning of Leads” provides for lead purchasers to rate lead sellers. U.S. patent application publication 2007/0027746 to Grabowich titled “Methods and System for Online Sales Information Exchange” describes a system where users can rate leads. In both cases, users can only rate leads based on a prior established rating systems as opposed to being able to create or define new ratings by which a lead can be rated.

What has yet to be appreciated is users could have their own preferred rating metrics when using web based services offering access to items or content, especially leads. Users could assign a tag to an item where the tag can be used as a foundation of a rating system. Other users can then rate the item with respect to the tag, ideally according to a rating scale representing a desirable metric.

Thus, there is still a need for methods for allowing users to define ratable tags and assign them to leads.

### SUMMARY OF THE INVENTION

The inventive subject matter provides apparatus, systems and methods in which users of a lead mining service can rate leads.

One aspect of the inventive subject matter includes a lead rating system comprising a lead tagging interface, a lead rating interface, and a lead viewer. A user can utilize the tagging interface to tag a lead with an attribute. The user coverts the tag into a rating object by also assigning a rating scale to the tag. Preferably the tag becomes available to other users (e.g., lead sellers, lead purchasers, other lead providing services, etc.) as they work the lead. Users can rate one or more leads having the tag by submitting a rating value according to the rating scale assigned to the tag. Preferably rating values from many different users are aggregated to form a tag rating for the lead. As users work leads, they can view the leads or their ratings via the lead viewer. Contemplated lead rating system can also include an analysis interface through which a user can interface to an analysis engine to analyze a value of one or more leads (e.g., a closing value, monetary value, etc.) with respect to one or more tag ratings.

In some embodiments, the tag rating is calculated by averaging at least some of the rating values submitted by users. In more preferred embodiments, the tag rating is calculated by using a weighting scale applied to the submitted rating values. The weighting scale can overweight or underweight a user's rating as desired.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic overview of a lead mining service hosting a lead rating system.

FIG. 2 is a schematic of an example lead tagging interface.

FIG. 3 is a schematic of an example lead rating interface.

FIG. 4 is a schematic of a lead viewer that presents a lead with its tag ratings.

FIG. 5 is a schematic of a lead analysis interface.

### DETAILED DESCRIPTION

### Overview

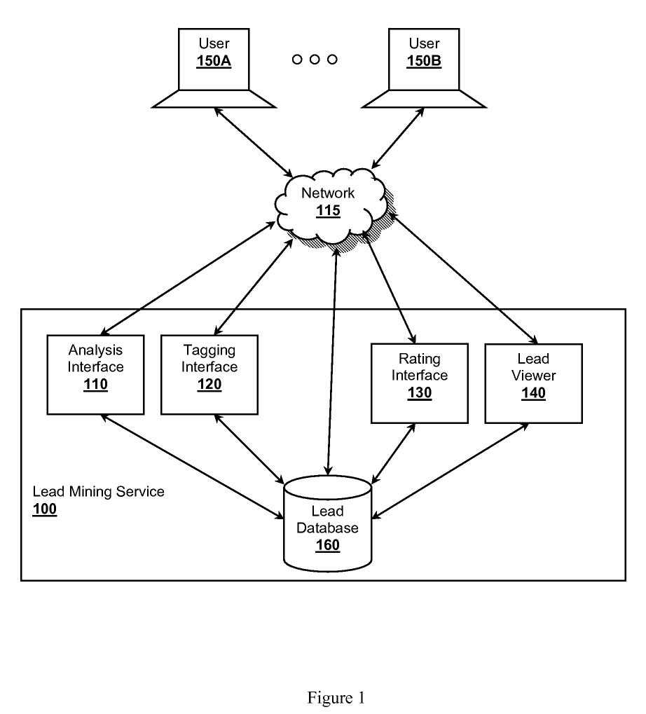

FIG. 1 depicts an environment where lead mining service 100 provides access to a lead rating system for use by one or more of users 150A through 150B, collectively referred to as users 150. In a preferred embodiment, a lead rating system comprises lead tagging interface 120, lead rating interface 130, or lead viewer 140. Users can access leads stored in lead database 160 directly or indirectly via one or more elements of lead mining service 100, preferably over network 115. In some embodiments, a lead rating system can include analysis interface 110 capable of analyzing the value of leads with respect to their ratings.

Lead mining service 100 preferably comprises a for-fee lead providing service. A preferred lead mining service is disclosed in co-owned U.S. patent application having Ser. No. 12/355,983 titled “Lead Mining, Systems and Methods”. Such approaches to lead mining are embodied by manyUP™ Corporation of Newport Beach, Calif. (http://www.manyup.com) through which leads can be exchanged, distributed, or re-monetized. In the manyUP model, multiple unaffiliated users work leads substantially in parallel. As users 150 work a lead, users 150 modify attributes of the leads, which can improve the lead's closing value (e.g., the lead's price, monetary values, acceptable result, etc.) to others.

Lead mining service 100 can be embodied by other services or software packages running on one or more computers, possibly HTTP servers, having software instructions stored on a computer readable media. For example, service 100 could include a Customer Relationship Management (CRM) software package only available internally to a business entity, or externally to multiple business, possibly comprising a Software-as-a-Service (SaaS) CRM that integrates the disclosed techniques. An example CRM SaaS that could benefit from integrating the contemplated lead rating system includes SalesForce.com™ (http://www.salesforce.com).

Users 150 represent entities that participate with lead mining service 100. Users 150 can include lead purchase, lead sellers, lead aggregators, CRM providers, lead management systems, or even lead mining services. Users 150 can be embodied by businesses, people, computer systems, or even lead mining service 100.

In a preferred embodiment, users 150 interact with service 100 over network 115. Network 115 preferably comprises the Internet through which unaffiliated users 150 can access leads in service 100. However, network 115 can also comprise other, more private networks including a LAN, WAN, WLAN, VPN, or other forms of networks, wired or wireless.

Leads are preferably stored within database 160 on a storage system (e.g., hard disk, solid state disk, RAID system, SAN, NAS, etc.). Database 160 can be implemented using any suitable database system, possibly including MySQL™, Microsoft™ Access™, Oracle™, Postgres SQL™, or other database systems. Database 160 preferably provides capability for searching for leads based on one or more attributes of a lead. In some embodiments, leads are stored as an N-tuple with respect to lead attributes which provides for ease of analysis by an analytic engine (not shown). However, any suitable database schema that facilitates for searching, storing, or exchanging leads can be used. It is also contemplated that leads can be serialized or stored using XML, which allows leads to be exchanged among one or more third party software packages beyond those available from service 100.

Although database 160 is shown as being logically within lead mining service 100, it is also contemplated that database 160 could be remote relative to the computers running service 150. For example, database 160 could be hosted by other lead providing services while being accessible over network 115.

Lead Rating Objects

In a preferred embodiment, ratings for leads are managed as lead rating objects that can be assigned to a lead by users 150 as desired or as authorized by mining service 100. Preferred lead rating objects comprise data structures that can be stored on database 160 along with the leads to which it is assigned, or even as a separate accessible entity. Preferred rating objects comprise an identifier by which the rating object can be accessed or referenced. Suitable identifiers include GUID, UUIDs, unique names, or other identifiers. For example, a rating object can be implemented as a programmatic widget having a GUID where the widget can be integrated with a lead.

Rating objects can be assigned to a lead by simply storing the rating object along with the lead, or by storing a pointer to the rating object. The pointer can include the rating object's identifier.

Preferably a rating object comprises a tag and a rating scale assigned to the tag. The tag can include descriptive text that is intended to describe an aspect, property, or characteristic of a lead by which a user can rate a lead. Example tags can include “Receptive to Calls”, “Sourced from ABC, Inc.”, “Likes Movies”, or any other description that a user would find valuable. Many other tags are possible beyond those in the previous simple list. The rating scale represents a scale of values to be used as a rating metric by which users can rate the lead.

Preferred rating scales include a low end and a high end of the scale. A example, somewhat minimal scale, includes a positive indictor and a negative indictor, possibly based on a “Thumbs Up” or “Thumbs Down” system. Users can rate a lead by selecting thumbs up or thumb down as their submitted rating value, where each selection increments a corresponding counter. More preferred scales have a finer granularity with values from a low number (e.g., 0, 1, etc.) to a high number (e.g., 10, 100, 1000, etc.). Scales can be represented by discrete integers (e.g., 1, 2, 3, 4, 5, 12, etc.), or by any real number (e.g., 2.178, 3.14, etc.). In some embodiments, a scale can be assigned any desirable unit of measurement, real or arbitrary (e.g., stars, thumbs, diggs, quatloos, etc.). One should appreciate that other non-numerical scales are also contemplated include subjective scales possibly based on ratings values similar to “Disagree”, “Slightly Disagree”, “Neutral”, and so on. Preferred scales, regardless of how they are presented, can be converted to a numerical representation (e.g., integers, real numbers, enumerations, logical values, etc.).

Preferred rating systems offer users the rating objects as programmatic user interface objects that can be assigned to a lead. Contemplated UI objects can include check boxes, sliders, radio button, text fields, or other UI objects capable of accepting a rating value. Such UI objects can be configured to allow a user to drag and drop a rating UI object onto a lead, where the rating object automatically integrates with the target lead.

In some embodiments, rating objects are treated as dynamic lead attributes where the lead attribute has metadata. A description of utilizing lead attributes having attribute metadata can be found in co-owned, pending U.S. patent application having Ser. No. 12/355,997 titled “Adaptive Lead Pricing” filed on Jan. 19, 2009. Accordingly, ratings objects can also be assigned metadata that characterizes the rating object, either common metadata or specific metadata. Rating metadata can include various data including identification of the rating object, identification of the user that created the rating or their affiliation, modification history, or time stamps associated with the rating. Rating object metadata allows lead mining service to filter ratings appropriately when conducting an analysis, presenting ratings to users 150 as discussed below, or tracking histories of how ratings values for a rating object changes over time.

Rating objects can also include a tag rating, possibly represented by metadata specific to the rating object assigned lead, representing how multiple users have rated a lead according to the corresponding to tag. A tag rating can be calculated by averaging over at least some of the rating values assigned to the tag according the rating scale by a plurality of users. In some embodiments, the tag rating can be calculated by a weighting scale where rating values assigned by some users or given more are less weight than others. For example, if a user has been found to be less than trustworthy or has been shown to produced low quality leads, that user's rating values can be weighted by a factor of less than one. Contemplated factors by which a rating value can be devalued include 0.9, 0.5, 0.2, 0.1, or even less. Preferably a weighting factor is a function of attributes associated with a user, or a user with respect to rating object metadata.

Rating objects can also be secured to prevent unauthorized access, possibly through metadata assigned to the rating object where the metadata can indicate an access level for the rating object and their corresponding tags. Restricted access becomes beneficial when an entity has a private set of metrics that are consider a trade secret. Such tags would not be visible to other user accessing the lead providing service. Contemplated access levels can indicate tags are global tags available to everyone, protected tags, private tags only available to specific users or their affiliations, or types of tags.

Tagging Interface

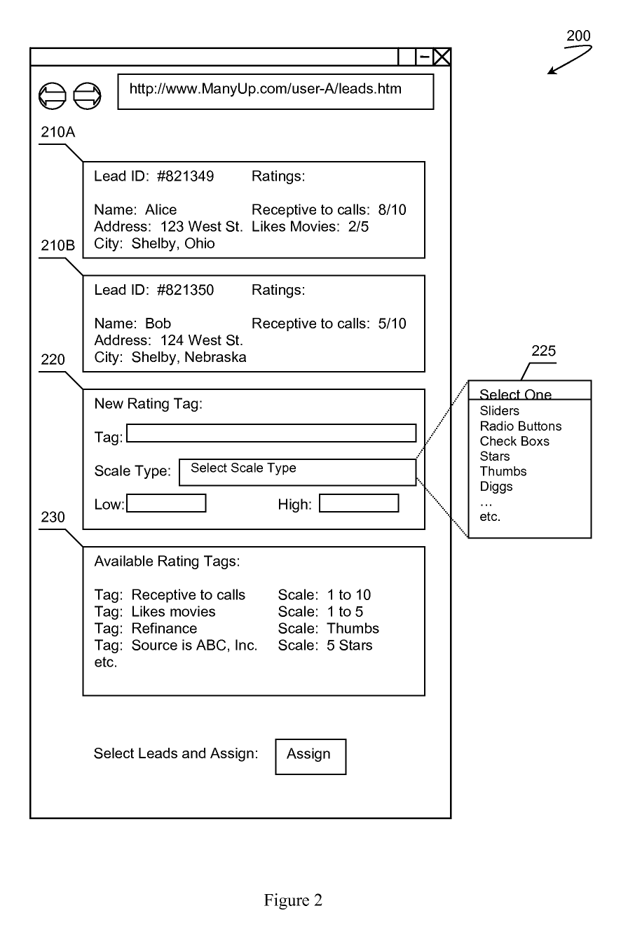

Preferred lead rating systems comprise a tagging interface, possibly similar to example tagging interface 200 as illustrated in FIG. 2. Tagging interface 200 preferably allows a user to dynamically assign a tag to lead and to assign a rating scale to the tag while a user is viewing or working a lead. In a preferred embodiment, a user can also assign the same rating object to each lead of a group of leads. It is also contemplated that a single rating object could be assigned to a group or a batch of leads where the rating object can be used to rate the batch as a single collective entity.

Tagging interface 200 can comprise a viewing component where one or more of leads 210A through 210B, collectively referred to as leads 210, can be viewed. Preferably tagging interface 200 also provides access to rating object creating component 220 through which a user can create a new rating object. For example, a user can create a rating object by entering a tag in a provided field and then selecting a suitable rating scale type, possibly through dropdown menu 225. The user can also select a desirable low or high end point for the scale if desired or if necessary by the scale type. One skilled in the art of user interfaces will appreciate that component 220 can take on many different forms including a drag and drop widget object can be placed integrated with a lead.

In a preferred embodiment, tagging interface 200 also provides listing 230 of available rating tags that can be assigned to one or more of leads 210. Listing 230 represents those rating objects that have previously been defined, created, or used and that are allowed to be assigned to leads 210. In some embodiments tagging interface 200 can restrict which rating objects are available to user by filter rating objects based on its metadata. Such an approach becomes desirable as the number of rating objects assigned to a lead grows. By filter the rating objects, the number of rating objects presented to a user can be reduced to a manageable level. For example, only rating objects having metadata indicating an affiliation with the user, or having metadata that relates to the attributes of leads 210 might be made available to a user.

Tagging interface 200 is presented as a web page served from a web server. However, other interfaces are also contemplated including computers having monitors or displays presenting a user interface of a software package, computers offering Application Programming Interfaces (APIs) either locally available via a library or remotely via a web service, a computer or computer system hosting an SaaS implementation via a network port, or other interface. The terms “interface” or “viewer” are used euphemistically to represent a computing device storing software instructions on a computer readable medium (e.g., RAM, flash, hard disks, solid state disks, etc.) where the computing device executes the software instructions to provide the functionality of the interface or viewer as described herein. It should be appreciated “interfaces” or “viewers” are considered to include hardware specifically adapted via software. In a preferred embodiment, hardware includes computers, computer systems, computing devices, (e.g., mobile phones, PDAs, etc.) monitors, network ports, or other digital electronic equipment.

It is also contemplated that tagging interface 200 can also be configured to allow users to modify a rating object that is assigned to lead 210. Users can modify rating objects, assuming proper authentication or authorization, by adding rating objects, removing rating objects, altering a tag, alerting a rating scale, resetting a tag rating of a rating object, or change a rating scale for a lead. In a preferred embodiment, only users having administrator or managerial authority can modify rating objects.

Rating Interface

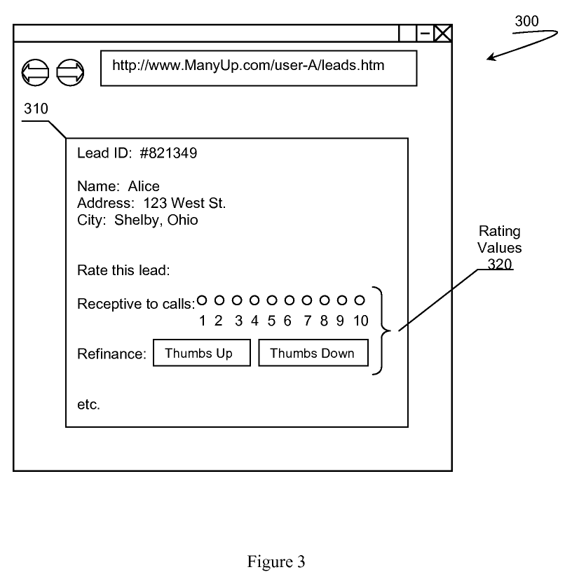

Once a rating object having a tag and a rating scale has been assigned to a lead, users can then rate the lead with respect to the tags. FIG. 3 presents an example rating interface 300 through which a user can rate one or more of leads 310 by setting rating values 320 according to one or more rating scales for the various tags. One should note that rating interface 310 can be of a similar form to a tagging interface as discussed above. It is also contemplated that a tagging interface and rating interface 210 can be combined or with any interface of a lead providing service.

Preferably rating interface 300 present leads 310 to a user along with assigned rating objects. As a user views or works a lead, the user can select one or more rating values 320 for the various rating scales. It is specifically contemplated that lead 310 could have many other rating objects assigned to it that are not available to a user. Rating interface 300 is preferably configured to restrict a user from viewing or accessing rating objects to which the user lacks permission. Rating interface 300 can restrict rating objects by comparing the rating object's metadata (e.g., an access level, affiliation, etc.) to corresponding user properties (e.g., password, key, affiliation, etc.) using any suitable authentication or authorization techniques.

In the example shown, a user can select a value 320 from 1 to 10 to rate lead 310 with respect to being “Receptive to Calls”, or could select a value 320 of “Thumbs Up” or “Thumbs Down” with respect to interest in a “Refinance”. The rating values 320 submitted by the user can then be collected by the lead rating system for aggregation with other rating values submitted by other users.

Aggregated Ratings

In a preferred embodiment, as previously discussed, rating values from a plurality of users can be aggregated together to form a tag rating for the rating object's tag. The tag rating can be calculated as an average over all ratings. In the case of a scale running from 1 to 10, a tag rating could be any value from 0 to 10, including fractional numbers. In the case of more discrete scales (e.g., thumbs up or thumbs down), the tag rating could be multi-valued having a number of thumbs up and a number of thumbs down. Additionally, the tag rating could be single-valued as a ratio of thumbs up to thumbs down.

As previously mentioned, tag ratings can be calculated based on a weighting scale as applied to the various rating values set by users. Any suitable weighting scale can be used. Example contemplated weighting scales operate based on identification of the user and ratings applied to a user. If a user has been rated as providing low quality information, their ratings values could be decreased as previously discussed. Other contemplated weighting scales include alerting ratings values based on the age of the rating values. For example, if a rating value was assigned a long time ago, its contribution to the tag rating could be decreased, or increased if desirable. Such an approach can be achieved through analyzing rating object metadata that encodes information regarding the history of the rating value of the tag. All weighting scales are contemplated.

It should be appreciated that many other multi-valued tag ratings are possible. For example, a tag rating could include an average over all rating and include a measure of precision. A measure of precision can comprise a width of a statistical distribution (e.g., Gaussian, Poisson, etc.) of ratings from leads having the same rating object. It is also contemplated that a multi-valued tag rating could comprise a history of tag ratings, possibly a having multiple average tag rating values where each average tag rating correspond to different time periods. Yet another example of a multi-valued tag rating includes storing an average tag rating along with the number of users that have rated the tag. It is also contemplated that the user who created a rating scale could have their rating values adjusted, if necessary, to ensure they do not game the rating system. All possible multi-valued tag ratings are contemplated.

Tag ratings can also be calculated by combining two or more rating objects to form a new rating object. The tag rating of the new rating object can be calculated as a function of the original tag ratings, or of the rating values associated with the original rating objects. Such an approach provides for customizing ratings to fit particular needs of a user. In such an embodiment, rating objects can take on a more programmatic nature where a user defines a function to be applied to form a tag rating for an aggregated rating object.

A contemplated lead rating system has access to a wealth of information about ratings. It is specifically contemplated that a tag rating for a rating object assigned to a lead can be tailored to a specific user. In one scenario, a user's own rating value can be removed, or added, from a tag rating of a lead. Furthermore, other rating values could be removed, or added, based on affiliations with the user (e.g., members of the same organization, employees of a company, members of the same division, etc.). Tailoring tag ratings to a user can also be performed as a function of the metadata assigned to the assigned rating objects. For example, a user could exclude all rating values set by another user, possibly a lead seller. Many other forms of tailoring a tag rating to a user can also be applied as desired.

Lead Viewer

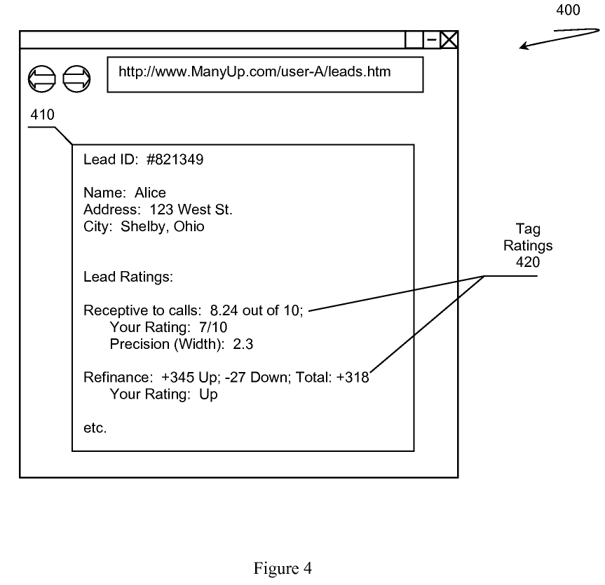

In FIG. 4, a user can use lead viewer 400 to view one or more leads 410 along with the leads' tag ratings 420. Although one of lead 410 is shown, one should appreciated that multiple leads can be presented, possibly in a spreadsheet format presenting multiple tag ratings for a lead where the lead's tags can represent columns of the spreadsheet.

In a preferred embodiment, lead viewer 400 is configured to present leads according to more than tag or tag rating. In some embodiments, leads 410 can be sorted by any one of their tag ratings. For example, a plurality of leads 410 could be sorted by a first tag rating preference (e.g., “Receptive to Calls”) and then by a second tag rating preference (e.g., “Refinance”). It is contemplated that a user could sort leads 410 according to any number of tag rating preferences.

Although lead viewer 400 is represented in FIG. 4 as a web page interface, it is also contemplated that viewer 400 can be implemented as other forms of interfaces as with a tagging interface or a rating interface. In fact, in some embodiments a lead viewer can be integrated with the other interfaces of a lead rating system or lead providing service.

Analysis Interface

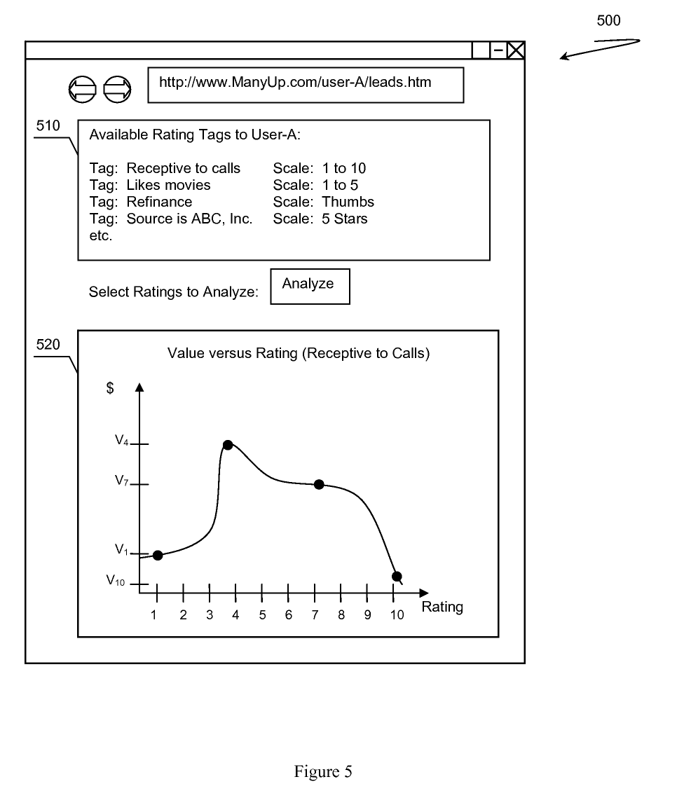

Some embodiments of lead rating systems also comprise an analysis interface, possibly similar to example analysis interface 500 illustrated in FIG. 5. Analysis interface 500 preferably is configured to present analysis results derived by an analytic engine (not shown) associated the lead providing service. A user can access an analysis engine via analysis interface 500 to compare the value of one or more leads with respect to their tag ratings 510. A user can select one or more 510 for comparison and interface 500 can present result 520 based on an analysis conducted by the analytic engine. One should note that an analysis engine is considered to include computer hardware that executes software instructions stored on a computer readable medium (e.g., RAM, flash, hard disk, solid state disk, etc.) configured to offer one or more analysis routines for analyzing leads.

In the example shown, result 520 is presented as a graph of lead value (e.g., monetary value, closing value, etc.) versus a tag rating. However, other results 520 can be presented including spreadsheets, graphs, charts, tag clouds, or other representations of data. It is specifically contemplated that interface 500 is configured to present analytic results that are multidimensional with respect to two or more tags from different rating objects. Multidimensional analysis of tag ratings provides insight into how ratings can interact and provide yet another tool for a lead mining service to determine values of leads, or to determine a future, predicted value of a lead based on rating trends.

One should note that a lead's value does not necessarily monotonically depend on a tag rating's value. Such a scenario is depicted by result 520 where the maximum value for leads having the tag “Receptive to Calls” is around a tag rating of four. The contemplated lead rating system allows users to gain insight into such unexpected results.

Although a lead's value as discussed herein is presented with respect to a monetary value, it should be appreciated the lead's closing value could be a non-monetary value. For example, a lead purchaser could be a representative for a political candidate. Lead's for such a purchaser would likely be considered valuable if an individual associated with the lead commits to vote, or more preferably commits to vote for the candidate. Another example of a non-monetary value could include responses to consumer surveys.

Additional Considerations

Although the preferred embodiment provides for tagging leads and rating the leads according to the tags, it is also contemplated that similar techniques can be applied to other items beyond leads. Additional contemplated applications include establishing ratings for the medical profession, automotive markets, goods or services, movies, or other areas where users have an interest in the opinions of others. Web based service companies would find such techniques useful to increase the value of their offering. Contemplated companies that would benefit from such approaches include eBay, Digg.com, Amazon™, Google™, or other web services.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A lead rating system, comprising:
a tagging interface configured to allow a first user to dynamically assign a tag to a lead and to assign a rating scale to the tag;
a rating interface configured to allow a second user to rate the lead with respect to the tag by setting a rating value for the tag according to the rating scale; and
a lead viewer configured to present the lead along with the tag and a tag rating calculated from the rating value.

2. The system of claim 1, wherein the tag rating comprises an aggregated rating calculated from the rating value and from previous rating values assigned to the tag by other users.

3. The system of claim 2, where the aggregated rating is calculated using a weighted scale.

4. The system of claim 1, wherein the tagging interface comprises a web services API.

5. The system of claim 1, wherein the first user is a lead purchaser.

6. The system of claim 1, wherein the tagging interface allows the first user to dynamically assign a second, different tag to the lead and to assign a second rating scale to the second tag.

7. The system of claim 1, further comprising an analysis interfaces that provides the second user access to an analysis of a value of leads having the tag with respect to the tag rating.

8. The system of claim 1, wherein the tagging interface provides for assigning the tag to a group of leads.

9. The system of claim 1, wherein the tag comprises a global tag.
